(19) United States
(12) Patent Application Publication
(10) Pub. No.: US 2011/0181375 A1
(43) Pub. Date: Jul. 28, 2011

(54) WAVEGUIDE

(75) Inventors: Yugang Ma, Singapore Science Park II (SG); Yaqiong Zhang, Singapore Science Park II (SG); Xiaobing Sun, Kanagawa (SG)

(73) Assignee: SONY CORPORATION, Tokyo (JP)

(21) Appl. No.: 12/977,156

(22) Filed: Dec. 23, 2010

(30) Foreign Application Priority Data
Jan. 4, 2010 (SG) 201000070-1

(51) Int. Cl. H01P 3/10

(52) U.S. Cl. 333/240; 333/26

(57) ABSTRACT

A waveguide comprising a SF_WG portion between a first transmission line and a second transmission line, wherein the SF_WG portion has a width greater than or equal to 75 um.

### FIELD OF THE INVENTION

The invention relates to a waveguide particularly though not solely to an SF_WG for MMW signals.

### BACKGROUND

The following abbreviations will be used in this specification:

| | |
|---|---|
| SF_WG | Sommerfeld waveguide |
| MMW | MilliMetre Wave |
| CPW | Coplanar Waveguide |
| MSL | Microstrip Line |
| PCB | Printed Circuit Board |
| IC | Integrated Circuit |
| EM | ElectroMagnetic |
| TEM | Transverse Electromagnetic Mode |
| TM01 | Transverse Magnetic Mode 01 |
| GSG | Ground Signal Ground |
| G-line | Goubau-line |

Communications signals may be carried over air or some other solid medium such as a wire. In case of high frequency signals, special structures such as waveguides are sometimes used to minimise radiation leakage and interference among adjacent channels. However, for certain high frequency signals such as MMW signals, using TEM based transmission lines or integrated waveguides may result in a high propagation loss.

Another transmission medium that can be used for MMW signals is a single metal wire SF_WG (or G-line) since this may have a lower propagation loss. However because of the special mode that a SF_WG operates in, the method of excitation is important. Depending on the application, the excitation can be from an antenna or a transmission line converter. An antenna may have a low converting efficiency because of the open EM-field. A more common prior art approach is using Sommerfeld wave excitations from a CPW.

FIG. 1(a) shows an A-type converter 100, where the wire width is 1 um (in FIG. 1(a), the wire is too thin to be seen) and FIG. 1(b) shows a B-type converter 104, where the wire width is 5 um. The very thin wires may be required to achieve an acceptable impedance matching for a wide bandwidth. Wire width of 1 um may be practical for IC fabrication but it may be too thin for PCB fabrication.

### SUMMARY OF THE INVENTION

In general terms in a first aspect the invention proposes a SF_WG for inter-board or inter-chip connections, where the width of the SF_WG is greater than or equal to 75 um.

In a second aspect the invention proposes a SF_WG with a length substantially similar to an integer multiple of half the wavelength at the central signal frequency.

One or more embodiments may have the advantage of:

simple, practical structure dimensions for fabrication;

very wide bandwidth;

low loss as compared with integrated waveguide and many other transmission lines;

transmission from vertical and horizontal bending may be minimised; and/or suitable for multiple parallel channels.

According a first particular expression of the invention, there is provided a waveguide according to claim 1.

According to a second particular expression of the invention, there is provided a waveguide according to claim 15. One or more embodiments may be implemented according to claims 2 to 14 or claims 16 to 36.

### BRIEF DESCRIPTION OF THE DRAWINGS

One or more example embodiments of the invention will now be described, with reference to the following figures, in which:

FIG. 1(a) is a schematic of a first prior art CPW to SF_WG transition,

FIG. 1(b) is a schematic of a second prior art CPW to SF_WG transition,

FIG. 2 is a schematic of a MSL to SF_WG transition according to a first example embodiment,

FIG. 3 is a schematic of a SF_WG on a PCB according to a second example embodiment,

FIG. 4 is a schematic of a SF_WG for IC die interconnection according to a third example embodiment,

FIG. 5 is a schematic of a MSL to SF_WG transition according to a fourth example embodiment,

FIG. 6 is a schematic of a CPW to SF_WG transition according to a fifth example embodiment,

FIG. 7 is a schematic of a CPW to SF_WG transition according to a sixth example embodiment,

FIG. 8 is a schematic of a SF_WG vertical bending protection structure according to a seventh example embodiment,

FIG. 9 is a schematic of a SF_WG horizontal bending protection structure according to an eighth example embodiment,

FIG. 10 is a schematic of a 2-channel SF_WG according to a ninth example embodiment, and

FIG. 11 is a graph of the test results obtained using a SF_WG according to the second example embodiment.

### DETAILED DESCRIPTION

A number of example embodiments will now be described for die-to-die interconnection using a SF-WG. One or more example embodiments may avoid the very thin wire required in the prior art, which may allow both IC and PCB fabrication.

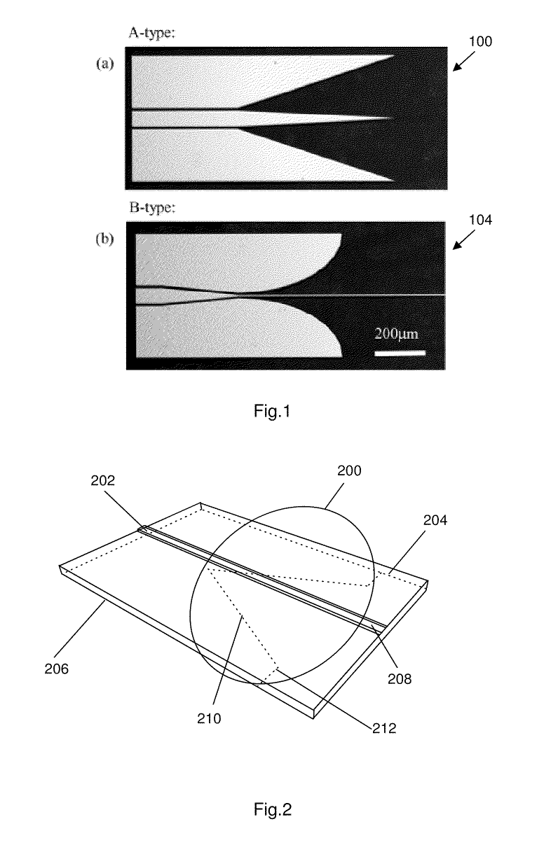

FIG. 2 shows a MSL to SF_WG transition 200 according to the first example embodiment. A MSL 202 is attached to the top major surface of a dielectric substrate 204 connected to a first IC (not shown). A ground plane 206 is attached on the bottom major surface of the substrate 204. The MSL 202 transitions into the SF_WG 208 by virtue of a notch 210 in the end 212 of the ground plane 206. The shape of the notch 210 can be linear or nonlinear (e.g. exponential), for example a triangular notch.

The MSL 202 width may be constant through to the SF_WG 208. The MSL 202 width may be determined by the dielectric substrate thickness, dielectric constant and desired characteristic impedance. For example, if the dielectric material thickness is 130 um, material dielectric constant is 10 and desired characteristic impedance is 50 ohm, then the trace width (i.e. MSL 202 and SF_WG 208 width) may be 100 um. By the use of the notch 210 the MSL mode can be converted to Sommerfeld (TM01) mode with the loss minimised. Also the width of the SF_WG 208 may stay constant and may not need to be very thin. For example the width of the SF_WG may be greater than or equal to 75 um which may allow for easy PCB fabrication.

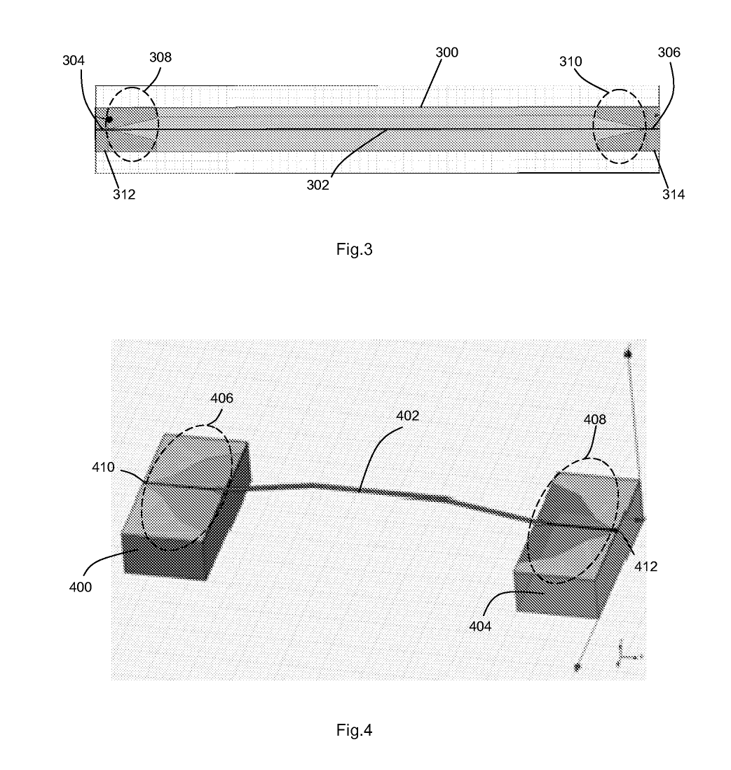

The MSL to SF_WG transition 200 according to the first example embodiment from FIG. 2 may be implemented on a PCB 300 as shown in FIG. 3 or on a IC die 400 as shown in FIG. 4.

The second example embodiment shown in FIG. 3 has a SF_WG 302 attached on a PCB 300 between a first MSL 304 and a second MSL 306. A first transition 308 is provided between the first MSL 304 and the SF_WG 302, and a second transition 310 is provided between the second MSL 306 and the SF_WG 302. A ground plane 312,314 is attached on the bottom of the PCB directly underneath the respective MSL 304,306.

The third example embodiment shown in FIG. 4 has a bond wire SF_WG 402 attached between a first IC die 400 and a second IC die 404. A first transition 406 is provided between a first MSL 410 on the first IC die 400 and the SF_WG 402, and a second transition 408 is provided between a second MSL 412 on the second IC die 404 and the SF_WG 402. Each of the transitions 406, 408 extends from its respective MSL 410, 412 to the bond wire SF_WG 402. Each MSL 410, 412 forms a trace on one side of its respective dielectric substrate and a ground plane is formed on the other side of each dielectric substrate. The ground plane in each transition 406, 408 may split or open under the trace formed by the MSL 410, 412 either linearly or non-linearly.

The disclosed transition according to the first example embodiment in FIG. 2 is more suitable for the PCB substrate or wire over air application, although it can be used on a IC die. This is because this transition does not require a very thin trace for impedance matching as that in FIG. 1. However, for IC die, the transition structure is usually required to be small for reducing cost. Moreover, since the loss tangent of the IC substrate, for example, silicon is usually high (in one example, 0.9) whereas the PCB material has a relatively lower loss tangent (in one example, 0.05), the transition loss for the application of the disclosed transition according to the first example embodiment in FIG. 2 on a IC die becomes larger than that on a PCB.

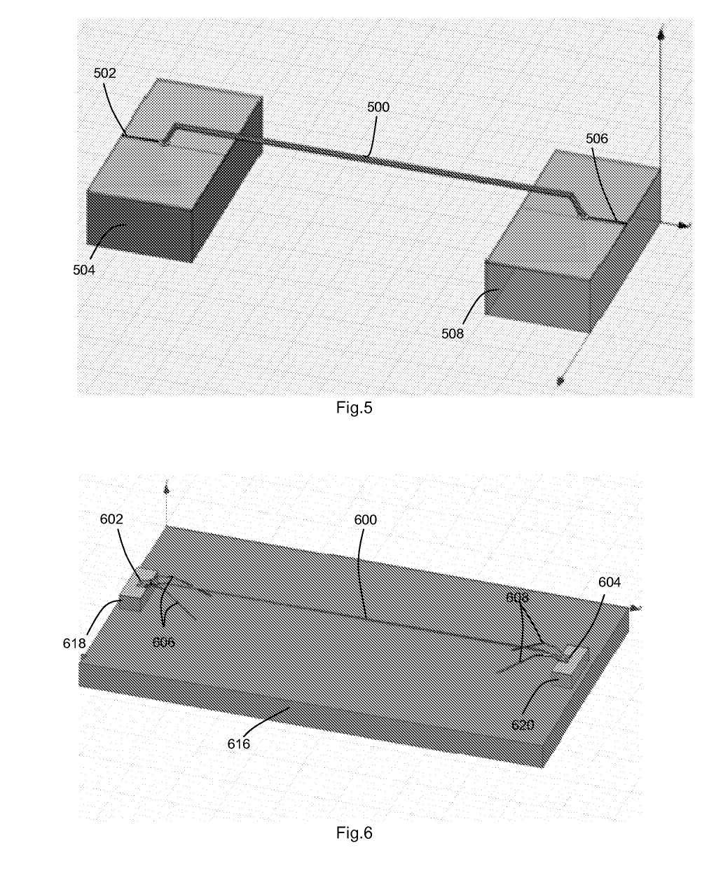

The fourth example embodiment shown in FIG. 5 has a bond wire SF_WG 500 attached between a first MSL 502 on a first IC die 504 and a second MSL 506 on a second IC die 508. Unlike the third example embodiment shown in FIG. 4 in which there is no requirement on the length of the bond wire SF_WG 402, the length of the bond wire SF_WG 500 in the fourth example embodiment in FIG. 5 is required to be an integer multiple of a half wavelength at the central signal frequency. Having the length of the bond wire SF_WG 500 as an integer multiple of a half wavelength at the central signal frequency ensures the conversion of the wave to Sommerfeld wave and provides good impedance matching. Furthermore, the width of each MSL 502, 506 is preferably the same as the width of the bond wire SF_WG 500. However, there is no requirement on the shape of the bond wire SF_WG 500. Similar to the third example embodiment in FIG. 4, there is also a ground plane associated with each MSL 502, 506.

The fifth example embodiment shown in FIG. 6 has a single wire SF_WG 600 with a length that is an integer multiple of a half wavelength at the central signal frequency. The single wire SF_WG 600 is connected between two CPW (GSG) 602, 604. There are two pairs of quarter wavelength wires 606,608. Each pair of wires 606,608 is bonded at one end to a ground pad on one of the CPW (GSG) 602, 604 and acts as a balun. The other end of each pair of wires 606, 608 is attached to an interposer 616 on which the IC dies 618,620 are attached. Each pair of balun wires 606,608 are spread at an angle of about 45 degrees.

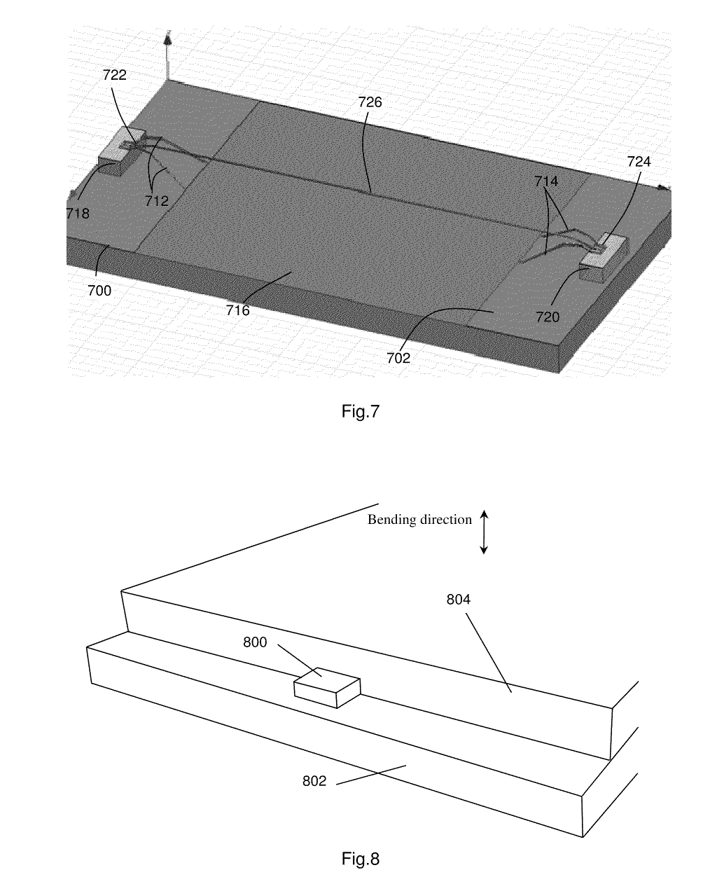

The sixth example embodiment shown in FIG. 7 is the same as the fifth example embodiment (i.e. it also comprises a single wire SF_WG 726 connected between two CPW (GSG) 722,724) except that a limited ground plane 700,702 is provided directly under each IC die 718,720 on the interposer 716. Instead of being attached to the interposer 716, the other end of each pair of balun wires 712, 714 is attached to the respective ground plane 700,702. With the ground planes 700,702, the sixth example embodiment in FIG. 7 may achieve a more stable performance.

One or more embodiments may be encapsulated in a dielectric material such as mould resin. In that case changes to the dimensions of the embodiments will be required according to the dielectric constant of the dielectric material.

Bending of a SF_WG may result in radiation and propagation loss. Although the SF_WG 402 and 500 in the third and fourth example embodiments respectively are bent, the distance between the IC dies may be short and hence bending loss may not be as important as coupling impedance matching and mode transition. However, this may not be the case for the second example embodiment in FIG. 3 and it may be preferable to reduce the radiation and propagation loss due to the bending of the SF_WG 302 in this embodiment. Bending of the SF_WG 302 in the second example embodiment in FIG. 3 can be separated into 1) vertical bending (orthogonal to the substrate plane) and 2) horizontal bending (on the substrate plane).

For type 1) bending, the radiation propagation loss may be reduced by the seventh example embodiment in FIG. 8. The SF_WG 800 is sandwiched by two dielectric layers 802, 804 with different dielectric constants. Dielectric layers 802, 804 may be made of any dielectric materials with low losses. The dielectric layers 802, 804 may have dielectric constants which differ only slightly from each other.

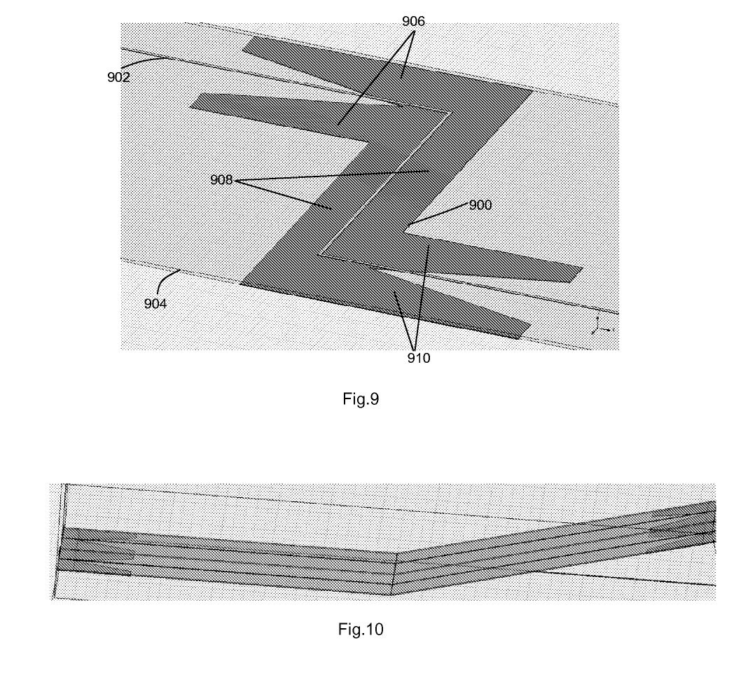

For type 2) bending, the eighth example embodiment shown in FIG. 9 may be used to reduce the radiation propagation loss. A metal patch 900 is provided under the SF_WG 902 and dielectric substrate 904. The metal patch 900 may comprise two ends and a notch at each end. In one example, the metal patch 900 may comprise three sections 906, 908 and 910 with the sections 906, 908 respectively joined to the sections 908, 910 at an angle as shown in FIG. 9. The sections 906, 908, 910 may be arranged in a z shape and the angle between the sections 906, 908, 910 may take on any value. The notch at either end of the metal patch 900 may be shaped linearly or nonlinearly (e.g. exponentially), such as triangular shaped. This converts the SF_WG 902 to a MSL and because a MSL is not sensitive to bending, the eighth example embodiment as shown in FIG. 9 may reduce losses caused by type 2) bending and in turn, may improve the performance of the SF_WG.

The ninth example embodiment is shown in FIG. 10 with a 2-channel SF_WG with each channel similar in structure to the second example embodiment. The channels may be separate structures attached together or may be integrated side by side. The bending of the 2-channel SF_WG in the ninth example embodiment in FIG. 10 is merely an example and the multi-channel SF_WG may also be straight or bent in a different manner.

The ninth example embodiment may also be protected from vertical and horizontal bending by using the seventh and eighth example embodiments, respectively. Also the third, fourth, fifth or sixth example embodiments may also be employed with multiple channels.

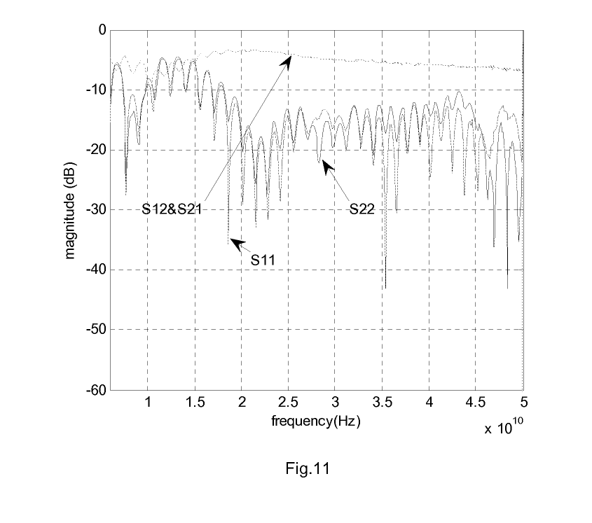

FIG. 11 shows the test results for a 600 mm length SF_WG using the second example embodiment from FIG. 3. In FIG. 11, the S-parameters of the SF_WG are plotted. In general, S-parameters describe the response of an N-port network (in this case N=2) to voltage signals at each port. The first number in the subscript of each S-parameter represents the responding port, whereas the second number in the subscript represents the incident port. As shown in FIG. 11, the S11 and S22 show a wide bandwidth and the S12&S21 shows the loss is low.

While example embodiments of the invention have been described in detail, many variations are possible within the scope of the invention as will be clear to a skilled reader.

1. A waveguide comprising:
a SF_WG portion between a first transmission line and a second transmission line, wherein the SF_WG portion has a width greater than or equal to 75 um.

2. A waveguide according to claim 1, wherein the width of each of the first and second transmission lines is the same as the SF_WG portion.

3. A waveguide according to claim 1, wherein the first and second transmission lines and the SF_WG portion are attached to a Printed Circuit Board.

4. A waveguide according to claim 1, wherein each of the first and second transmission lines is attached to an IC die.

5. A waveguide according to claim 4, wherein the SF_WG portion is a bond wire.

6. A waveguide according to claim 1, further comprising:
a first transition portion between the first transmission line and the SF_WG portion, and
a second transition portion between the second transmission line and the SF_WG portion.

7. A waveguide according to claim 6, wherein each of the first and second transition portions comprises a ground plane, the ground plane further comprising a notch at one end.

8. A waveguide according to claim 7, wherein the shape of the notch is linear.

9. A waveguide according to claim 8, wherein the shape of the notch is triangular.

10. A waveguide according to claim 7, wherein the shape of the notch is non-linear.

11. A waveguide according to claim 10, wherein the notch is exponentially shaped.

12. A waveguide according to claim 1, wherein the length of the SF_WG portion is an integer multiple of a half wavelength at the central signal frequency.

13. A waveguide according to claim 1, wherein the first and second transmission lines are MSL.

14. A waveguide according to claim 1, wherein the first and second transmission lines are CPW.

15. A waveguide comprising:
a SF_WG portion between a first transmission line and a second transmission line,
wherein the length of the SF_WG portion is substantially similar to an integer multiple of a half wavelength at the central signal frequency.

16. A waveguide according to claim 15, wherein the SF_WG portion is a bond wire.

17. A waveguide according to claim 16, wherein the bond wire is substantially straight.

18. A waveguide according to claim 15, wherein the widths of the first and second transmission lines are equal to the width of the SF_WG portion.

19. A waveguide according to claim 15, wherein the first and second transmission lines are MSL.

20. A waveguide according to claim 15, wherein the first and second transmission lines are CPW.

21. A waveguide according to claim 15, further comprising a balun bonded to each of the first and second transmission lines.

22. A waveguide according to claim 21, wherein the balun further comprises two quarter wavelength wires.

23. A waveguide according to claim 22, wherein the two quarter wavelength wires in the balun are spread at an angle of 45 degrees.

24. A waveguide according to claim 21, wherein the balun is further bonded to a ground plate.

25. A waveguide according to claim 15, wherein each of the first and second transmission lines is attached to an IC die.

26. A waveguide according to claim 1, wherein the SF_WG portion is sandwiched by two dielectric layers.

27. A waveguide according to claim 26, wherein the dielectric constants of the two dielectric layers are different.

28. A waveguide according to claim 1, further comprising a metal patch under at least part of the SF_WG portion, the metal patch comprising two ends and a notch at each end.

29. A waveguide according to claim 28 further comprising a substrate between the metal patch and the part of the SF_WG portion.

30. A waveguide according to claim 28, wherein the notch is shaped linearly.

31. A waveguide according to claim 30, wherein the notch is triangular shaped.

32. A waveguide according to claim 28, wherein the notch is shaped non-linearly.

33. A waveguide according to claim 32, wherein the notch is exponentially shaped.

34. A waveguide structure comprising a plurality of waveguides according to claim 1.

35. A waveguide structure comprising one or more waveguides according to claim 1, wherein the one or more waveguides are encapsulated in a dielectric material.

36. A waveguide structure according to claim 35, wherein the dielectric material is mould resin.
